(19) United States
(12) Patent Application Publication
(10) Pub. No.: US 2006/0028660 A1
(43) Pub. Date: Feb. 9, 2006

(54) Encoder of an image forming apparatus

(76) Inventor: Su-min Lim, Seoul (KR)

Correspondence Address: STANZIONE & KIM, LLP, 919 18TH STREET, N.W., SUITE 440, WASHINGTON, DC, 20006, US

(21) Appl. No.: 11/189,850

(22) Filed: Jul. 27, 2005

(30) Foreign Application Priority Data
Aug. 7, 2004 (KR) 2004-62213

(51) Int. Cl. G06K 15/10

(52) U.S. Cl. 358/1.5

(57) ABSTRACT

An encoder of an image forming apparatus includes an encoder scale positioned along a movement path of a carriage that has a recording/reading head mounted thereon and reciprocates along the movement path, at least one sensor to measure displacement of the carriage with reference to the encoder scale, and at least one cleaning unit disposed opposite a surface of the encoder scale to clean the surface of the encoder scale. The at least one cleaning unit includes a rotary body disposed on the carriage, a plurality of unit blades protruding from the rotary body at regular intervals in a radial arrangement, and a cleaning member disposed at a leading end of each of the unit blades to clean the surface of the encoder scale. Since the cleaning members of the unit blades are rotated and are periodically used to clean the encoder scale, a cleaning efficiency can be maintained for an extended period of time.

### CROSS-REFERENCE TO RELATED APPLICATIONS

This application claims the benefit of Korean Patent Application No. 2004-62213 filed Aug. 7, 2004, in the Korean Intellectual Property Office, the disclosure of which is incorporated herein by reference in its entirety.

### BACKGROUND OF THE INVENTION

1. Field of the Invention

The present general inventive concept relates to an image forming apparatus which moves a carriage including an information reading/recording head to output text or image information and an encoder to sense a position and a movement speed of the carriage. More particularly, the present general inventive concept relates to a cleaner to clean the encoder.

2. Description of the Related Art

An image forming apparatus (e.g., an inkjet printer) reciprocates a recording head to scan or record text or image information. FIG. 1 is a schematic perspective view illustrating an image forming apparatus having an encoder 20. As illustrated in FIG. 1, the image forming apparatus includes a carriage 12 having a recording head 11 mounted thereon to reciprocate in a linear pattern, and an encoder 20 employed as a sensing part to sense a position and a scanning speed of the carriage 12. The image forming apparatus includes a main chassis 1 which forms a main body thereof. A timing belt 3 provides the linear reciprocating movement of the carriage 12. A guide shaft 4 guides the linear reciprocation of the carriage 12.

FIG. 2 is a schematic view illustrating the encoder 20 of the image forming apparatus of FIG. 1. Referring to FIG. 2, the encoder 20 includes an encoder sensor 21, an encoder scale 22, a sensor housing 23, and a conventional encoder cleaner (described below).

The encoder sensor 21 includes a pair of transmittable optical sensors which are disposed in recesses within the sensor housing 23 and positioned opposite to and facing each other. The sensor housing 23 is mounted to the carriage 12 and includes a passage through which the encoder scale 22 extends.

The optical sensors are electrically connected to a baseboard (not shown) of the carriage 12. The optical sensors sense light transmitting and non-light transmitting parts of the encoder scale 22 to determine the position and the scanning speed of the carriage 12.

The encoder 20 includes the conventional cleaner for cleaning the encoder scale 22.

Referring to FIG. 2, the conventional encoder cleaner includes a cleaning member 24, which is typically formed of a material such as a sponge or a fabric. The cleaning member 24 is mounted within the sensor housing 23 to contact both surfaces of the encoder scale 22, respectively. Since the cleaning member 24 contacts both surfaces of the encoder scale 22, a cleaning operation is performed as the carriage 12 moves.

The conventional encoder cleaner, however, has the following problems. The conventional encoder cleaner may need to be replaced. However, the conventional encoder cleaner is typically fixed in place, which does not allow for easy replacement.

Additionally, during operation of the image forming apparatus, the conventional encoder cleaner accumulates foreign substances which are mainly removed from the surfaces of the encoder scale 22. However, the accumulated foreign substances are transferred back to the encoder scale 22 as the cleaning operation is repeated, and therefore re-contaminates the encoder scale 22 and degrades efficiency of the cleaning operation. As a result, the position and the movement speed of the carriage 12 can not be determined with precision. This can cause a degradation of information recording quality and/or a malfunction of mechanical parts of the image forming apparatus.

### SUMMARY OF THE INVENTION

The present general inventive concept provides a cleaning unit which can improve precision and efficiency of an encoder for an extended period of time, and an encoder having the same. The present general inventive concept also provides an image forming apparatus having the encoder.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an encoder of an image forming apparatus, including: a sensor housing disposed on a carriage that has a recording/reading head mounted thereon and reciprocates along a movement path, an encoder scale positioned along the movement path of the carriage, at least one sensor disposed within the sensor housing to measure displacement of the carriage with reference to the encoder scale, and at least one cleaning unit rotatably disposed on the sensor housing opposite a surface of the encoder scale to clean the surface of the encoder scale.

The at least one cleaning unit may include a rotary body rotatably disposed on the sensor housing, a plurality of unit blades protruding from the rotary body at regular intervals in a radial arrangement, and a cleaning member disposed on a leading end of each of the plurality of unit blades to selectively contact the surface of the encoder scale according to a rotational movement of the rotary body.

The at least one cleaning unit may further include a driving bar to contact one of the plurality of unit blades to rotate the rotary body by a step of a predetermined pitch.

The at least one cleaning unit may include a pair of cleaning units to correspond to both surfaces of the encoder scale. The rotary body may be forcibly rotated by the driving bar by the step of the predetermined pitch. A leading end of each unit blade may be bent at a predetermined angle to selectively contact the encoder scale according to a position thereof. The driving bar may have an end which is bent at a predetermined angle to contact and rotate one of the plurality of unit blades.

A leading end of each unit blade may have a width that is substantially equal to a width of the encoder scale.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic perspective view illustrating an image forming apparatus having an encoder;

FIG. 2 is a schematic view illustrating the encoder of the image forming apparatus of FIG. 1;

FIG. 3 is a schematic view illustrating an encoder of an image forming apparatus according to an embodiment of the present general inventive concept;

FIG. 4 is a schematic perspective view illustrating the encoder of the image forming apparatus of FIG. 3;

FIGS. 5A and 5B include a schematic side view and plan view, respectively, illustrating the structure of an encoder cleaning unit of an image forming apparatus according to an embodiment of the present general inventive concept; and

FIG. 6 is a schematic view illustrating operation of an encoder cleaning unit of an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

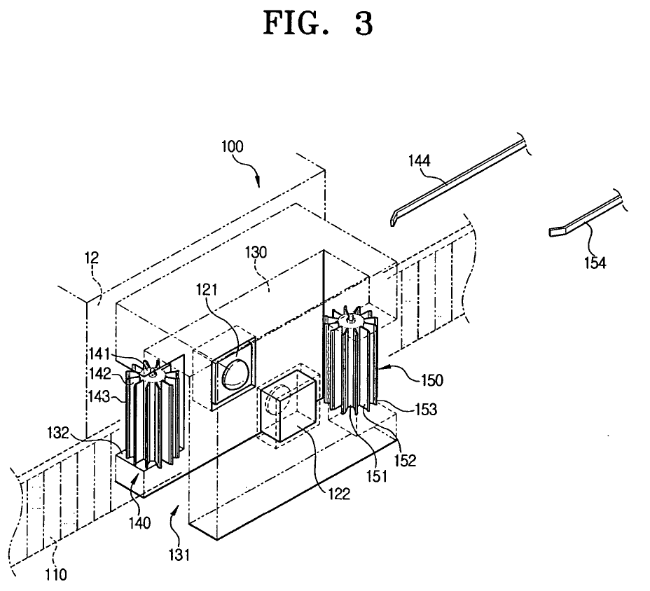

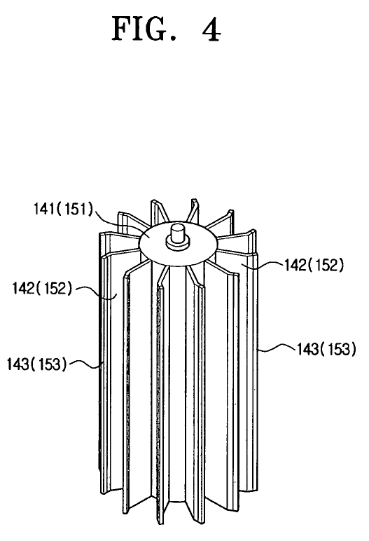

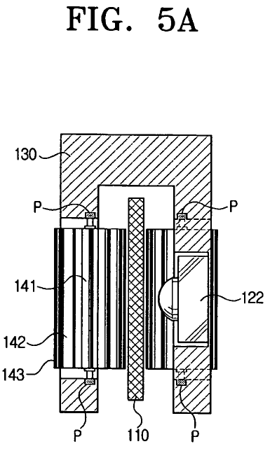

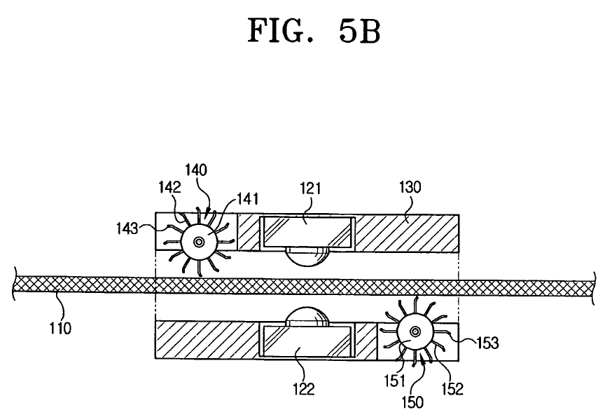

FIG. 3 is a schematic view illustrating an encoder of an image forming apparatus according to an embodiment of the present general inventive concept; FIG. 4 is a schematic perspective view illustrating the encoder of image forming apparatus of FIG. 3; and FIGS. 5A and 5B include a schematic side view and plan view, respectively, illustrating the structure of an encoder cleaning unit of an image forming apparatus according to an embodiment of the present general inventive concept. Referring now to FIGS. 3, 4, 5A, and 5B, an encoder 100 of an image forming apparatus according to an embodiment of the present general inventive concept includes an encoder scale 110 formed in a linear manner with respect to a movement path of a carriage 12, a sensor housing 130 which is mounted to the carriage 12 to move with the carriage 12 along the movement path while allowing the encoder scale 110 to pass therethrough, encoder sensors 121 and 122 mounted within the sensor housing 130 to correspond to both surfaces of the encoder scale 110, respectively, and cleaning units 140 and 150 provided on the sensor housing 130 to clean the respective surfaces of the encoder scale 110.

The cleaning units 140 and 150 may be mounted on both ends of the sensor housing 130 and on opposite sides of the movement path in a diagonal relation such that each of the cleaning units 140 and 150 can face each corresponding surface of the encoder scale 110. Alternatively, the cleaning units 140 and 150 may be provided on one end of the sensor housing 130 and on both sides of encoder scale 110 opposite with respect to one another. Furthermore, the cleaning units 140 and 150 may be mounted on the carriage 12 to correspond to both surfaces of the encoder scale 110. The cleaning units 140 and 150 may be employed to separately move with respect to each of the corresponding surfaces of the encoder scale 110.

The cleaning units 140 and 150 include rotary bodies 141 and 151 rotatably disposed on the sensor housing 130, a plurality of unit blades 142 and 152 protruding from an outer circumference of the rotary bodies 141 and 151 in a radial arrangement, cleaning members 143 and 153 provided on leading ends of the unit blades 142 and 152 to selectively contact one side (i.e., the corresponding surface) of the encoder scale 110 according to a rotational movement of the rotary bodies 141 and 151, and driving bars 144 and 154 to selectively push one of the plurality of unit blades 142 and 152 when the carriage 12 is at a return position to rotate the rotary bodies 141 and 151 according to steps of a predetermined pitch.

The rotary bodies 141 and 151 may be mounted on the sensor housing 130 of the carriage 12 to correspond to both surfaces of the encoder scale 110. Alternatively, the rotary bodies 141 and 151 may be positioned to separately move along the encoder scale 110.

The sensor housing 130 comprises a U-shaped block having a hole 131 that forms a passage extending lengthwise therethrough to accommodate the encoder scale 110. Alternatively, the sensor housing 130 may have other shapes that allow the passage to be formed along the movement path to accommodate the encoder scale 110 therein. The hole 131 that extends along the sensor housing 130 enables the encoder scale 110 to pass through the passage formed thereby. Recesses 132 are arranged in both inner walls of the passage defined by the hole 131. The recesses 132 accommodate the rotary bodies 141 and 151 and may be positioned in a diagonal relation. The recesses 132 may alternatively be positioned in other arrangements.

The encoder scale 110 may be formed, for example, by forming a photosensitive layer on a surface of a strip or a ribbon of a film (e.g., PET), and forming an alternating pattern of light transmitting and non-transmitting parts using laser exposure and developing processes along a lengthwise direction of the film. The encoder scale 110 is positioned along a central axis of the hole 131 of the sensor housing 130 and between the encoder sensors 121 and 122, and is capable of maintaining stability while the carriage 12 moves along the movement path.

The encoder sensors 121 and 122 may include, for example, transmittable optical sensors. The encoder sensors 121 and 122 may be positioned in an opposite relation with respect to each other in a middle portion of the inner walls of the passage defined by the hole 131 of the sensor housing 130.

Accordingly, the transmittable optical sensors (i.e., the encoder sensors 121 and 122) sense the position and the movement speed of the carriage 12 using the light transmitting parts and the light non-transmitting parts of the encoder scale 110. The encoder sensors 121 and 122 output corresponding signals to a baseboard (not shown) of the carriage 12 to which the transmittable optical sensors are electrically connected.

The rotary bodies 141 and 151 are mounted in the recesses 132 in the inner walls of the sensor housing 130, respectively. The rotary bodies 141 and 151 may be exposed through openings at the recesses 132, and are rotated by the steps of the predetermined pitch by applying a force from an external interference, restriction, or the like.

The rotary bodies 141 and 151 are forcibly rotated by one step of the predetermined pitch during a period of one reciprocal movement of the carriage 12. More specifically, the rotary bodies 141 and 151 are rotated by the push provided by the driving bars 144 and 154 (described below).

The rotary bodies 141 and 151 are integrally formed with their axes to restrict free rotation during the reciprocal movement of the carriage 12. Additionally, a friction member P (FIG. 5A) made of a high friction material, such as rubber, leather, fabric felt, etc. is disposed between the axes of the rotary bodies 141 and 151 and corresponding axis holes in the recesses 132 of the sensor housing 130 such that the rotary bodies 141 and 151 can be forcibly rotated by the external physical force provided by the driving bars 144 and 154.

The rotary bodies 141 and 151 may be formed to have a cylinder or column shape of a predetermined diameter and radius. The rotary bodies 141 and 151 may have a length that is similar to, or the same as, a width of the encoder scale 110.

The unit blades 142 and 152 extend from an outer circumference of the rotary bodies 141 and 151 in a radial arrangement at regular intervals. The regular intervals between the respective unit blades 142 and 152 may be appropriately adjusted according to a period of rotation. In other words, the driving bars 144 and 154 change a current unit blade from among the plurality of unit blades 142 and 152 that are used to clean the surface of the encoder scale 110 during a current reciprocal movement of the carriage 12 to a next unit blade that is used to clean the surface of the encoder scale 110 during a next reciprocal movement of the carriage 12. The reciprocal movement includes a movement of the carriage 12 from one end of the image forming apparatus to the other end of the image forming apparatus and back along the movement path. Since each of the unit blades 142 and 152 is used to clean a corresponding surface of the encoder scale 110 during a single reciprocal movement of the carriage 12, the period of rotation of the rotary bodies 141 and 152 is determined by a number of the unit blades 142 and 152. Accordingly, the number of the unit blades 142 and 152 can be increased or decreased according to the length of the step of the predetermined pitch and the rotational movement of the rotary bodies 141 and 151.

According to the present general inventive concept, the period of rotation according to the reciprocal movement of the carriage 12 can be extended by arranging a plurality of unit blades 142 and 152 at small intervals. By arranging the plurality of unit blades 142 and 152 at small intervals, each of the cleaning members 143 and 153 at the leading ends of each of the unit blades 142 and 152 is used less frequently. Thus, a replacement period and a lifespan of the cleaning units 140 and 150 can be extended.

Each of the unit blades 142 and 152 may have a structure in which the leading end is bent toward a direction of rotation, and the bent part of the leading end is provided with the cleaning members 143 and 153, such as a sponge or a fabric material. This structure enables the surface of the encoder scale 110 to contact the cleaning members 143 and 153 at a predetermined angle.

The unit blades 142 and 152 protrude from the outer circumference of the rotary bodies 141 and 151 to a predetermined length to enable sufficient contact with the corresponding surface of the encoder scale 110.

The unit blades 142 and 152 are arranged to be partially exposed through the openings at the recesses 132 of the sensor housing 130 to enable the driving bars 144 and 154 to push the unit blades 142 and 152, resulting in the rotational movement of the rotary bodies 141 and 151.

The unit blades 142 and 152 have a total width that is approximately equal to a width of the encoder scale 110 such that the cleaning members 143 and 153 can completely contact one side of the encoder scale 110.

The driving bars 144 and 154 each has a leading end which is bent at a predetermined angle to selectively move (i.e., push) one of the unit blades 142 and 152. Accordingly, each of the unit blades 142 and 152 is prevented from interfering with the other unit blades 142 and 152 when being forcibly rotated by one step of the predetermined pitch by the driving bars 144 and 154.

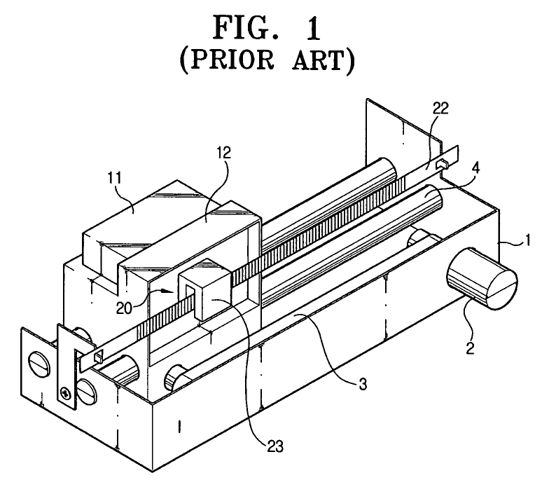

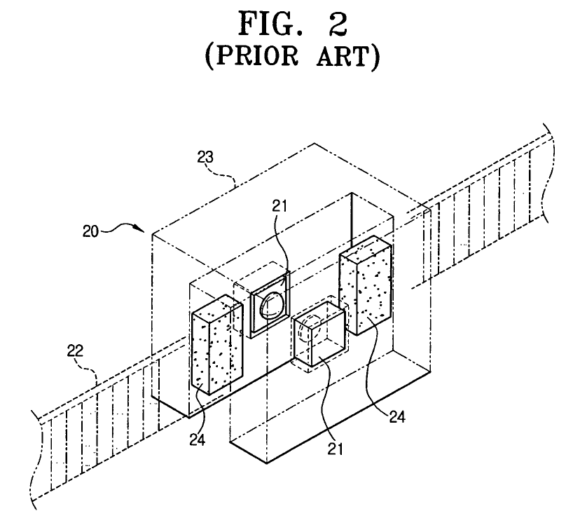

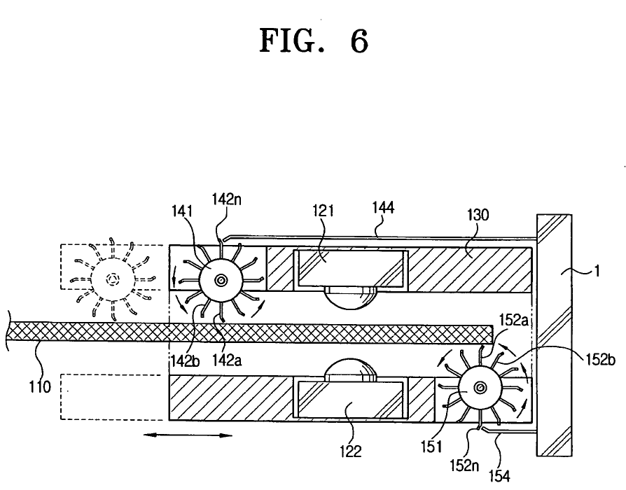

FIG. 6 is a schematic view illustrating operation of the encoder cleaning units 140 and 150 (FIG. 3) of an image forming apparatus according to an embodiment of the present general inventive concept. The driving bars 144 and 154 are formed on a main chassis 1 (similar to FIG. 1) of the image forming apparatus such that the driving bars 144 and 154 can protrude to different lengths around a return point of a certain end during the reciprocal movement of the carriage 12.

Operation of the cleaning units 140 and 150 (FIG. 3) of the image forming apparatus according to an embodiment of the present general inventive concept will now be described with reference to FIG. 6 and other figures described above.

The carriage 12 reciprocates along the encoder scale 110 such that the recording head (not shown) can read and record information including text and/or images. When the carriage 12 arrives at a return point of a certain end of the reciprocal movement, for example, when the carriage 12 arrives at the return point at a left-hand side of the movement path of FIG. 6, the driving bars 144 and 154 push the unit blades 142 and 152, thereby exerting an external force thereon. More specifically, the driving bars 144 and 154 push first unit blades 142n and 152n among the plurality of unit blades 142 and 152 which are disposed at a side of the rotary bodies 141 and 151 that is opposite to the encoder scale 110 and are not in contact therewith. Accordingly, the rotary bodies 141 and 151 are rotated by one step of the predetermined pitch (i.e., to next ones of the unit blades 142 and 152).

According to the rotation of the rotary bodies 141 and 151 by the one step of the predetermined pitch, all the unit blades 142 and 152 including second unit blades 142a and 152a, which are in contact with the surface of the encoder scale 110, are rotated together by one step of the predetermined pitch.

Accordingly, the cleaning members 143 and 153 at the leading ends of the second unit blades 142a and 152a are separated from the surface of the encoder scale 110 by the rotational movement. Thus, the cleaning members 143 and 153 of other unit blades are moved into contact with the encoder scale 110. That is, the cleaning members 143 and 153 of third unit blades 142b and 152b, which are adjacent to the second the unit blades 142a and 152a, are moved into contact with the surface of the encoder scale 110 by the rotational movement. Accordingly, the cleaning members 143 and 153 clean the surface of the encoder scale 110 during the reciprocal movement of the carriage 12 along the movement path. Each time the carriage 12 arrives at the return point (i.e., the return point at a left hand side or a right hand side of the reciprocal movement), one of the unit blades 142 and 152 on each of the rotary bodies 141 and 151 are pushed one by one by the driving bars 144 and 154, respectively, to rotate the next ones of the unit blades 142 and 152 to the corresponding surfaces of the encoder scale 110. Therefore, different cleaning members 143 and 153 can be used to clean the surfaces of the encoder scale 110 in each period of reciprocal movement.

As described above in various embodiments of the present general inventive concept, cleaning members of a cleaning unit that cleans surfaces of an encoder scale are periodically replaced with one another according to a period of reciprocal movement of a carriage having the cleaning units thereon. Therefore, precision and efficiency of encoder scale cleaning can be improved, and effective cleaning by the cleaning unit can be maintained for an extended period of time.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An encoder of an image forming apparatus, comprising:
a sensor housing disposed on a carriage that has a recording/reading head mounted thereon and reciprocates along a movement path;
an encoder scale positioned along the movement path of the carriage;
at least one sensor disposed in the sensor housing to measure displacement of the carriage with reference to the encoder scale; and
at least one cleaning unit rotatably disposed on the sensor housing opposite a surface of the encoder scale to clean the surface of the encoder scale.

2. The encoder of claim 1, wherein the at least one cleaning unit comprises a pair of cleaning units to correspond to both surfaces of the encoder scale.

3. The encoder of claim 1, wherein the at least one cleaning unit comprises:
a rotary body rotatably disposed on the sensor housing;
a plurality of unit blades protruding from the rotary body at regular intervals in a radial arrangement; and
a cleaning member disposed on a leading end of each of the plurality of unit blades to selectively contact the surface of the encoder scale according to a rotational movement of the rotary body.

4. The encoder of claim 3, wherein the cleaning unit further comprises:
a driving bar to contact one of the plurality of unit blades to rotate the rotary body by a predetermined step.

5. The encoder of claim 4, wherein the rotary body is forcibly rotated by the driving bar by the predetermined step.

6. The encoder of claim 4, wherein the driving bar includes a pair of driving bars of different lengths to correspond with a pair of rotary bodies.

7. The encoder of claim 4, wherein the driving bar has an end which is bent at a predetermined angle to contact and rotate one of the plurality of unit blades.

8. The encoder of claim 7, wherein the driving bar includes a pair of driving bars of different lengths to correspond to a pair of rotary bodies.

9. The encoder of claim 4, wherein the plurality of unit blades are formed such that the plurality of unit blades are partially exposed to an outside of the sensor housing to be contacted by the driving bar.

10. The encoder of claim 3, wherein the rotary body comprises one of a column member and a cylindrical member and has a length that is substantially equal to a width of the encoder scale.

11. The encoder of claim 3, wherein a leading end of each unit blade is bent at a predetermined angle to selectively contact the encoder scale according to a position thereof.

12. The encoder of claim 3, wherein a leading end of each unit blade has a width that is substantially equal to a width of the encoder scale.

13. The encoder of claim 3, wherein the cleaning member is formed to tightly contact the encoder scale.

14. An encoder of an image forming apparatus having a carriage to move reciprocally therewithin, the encoder comprising:
a housing having an opening to accommodate an encoder scale and disposed on the carriage to move reciprocally with the carriage along the encoder scale; and
at least one cleaning unit having a plurality of cleaning members and disposed on an end of the housing along at least one surface of the encoder scale to clean the at least one surface of the encoder scale with the plurality cleaning members.

15. The encoder of claim 14, further comprising:
at least one encoder sensor disposed on an inner wall of the housing on a side of the encoder scale to read the encoder scale to determine at least a position of the carriage along a reciprocal movement path.

16. The encoder of claim 14, wherein the housing repeatedly moves along the encoder scale with the carriage between a first position that corresponds to a first end of a reciprocal movement path and a second position that corresponds to a second end of the reciprocal movement path.

17. The encoder of claim 16, wherein the at least one cleaning unit comprises a rotary body having the plurality of cleaning members extending therefrom such that a selected cleaning member of the plurality of cleaning members cleans the at least one surface of the encoder scale.

18. The encoder of claim 17, further comprising:
a driving part to alternate the selected cleaning member from a current cleaning member used to clean the at least one surface during a current reciprocal movement to a next cleaning member used to clean the at least one surface during a next reciprocal movement.

19. The encoder of claim 17, wherein the selected cleaning member is changed each time the housing is moved into the first position.

20. The encoder of claim 17, further comprising:
at least one driving bar extending from a body of the image forming apparatus parallel to the reciprocal movement path to apply a force to one of the plurality of cleaning members to rotate the rotate the rotary body to change the selected cleaning member.

21. The encoder of claim 20, wherein the housing further comprises at least one recess in at least one end thereof to accommodate the at least one cleaning unit therein such that the at least one cleaning unit is partially exposed and the plurality of cleaning members of the at least one cleaning unit are contactable by the driving bar at the first position of the reciprocal movement path.

22. The encoder of claim 21, wherein the at least one cleaning unit further comprises a rotation axis having ends inserted in corresponding axis holes in the at least one recess in the housing about which the rotary body is rotatable, and the ends of the rotation axis have a friction part inserted into the corresponding axis holes such that the rotary body is not rotatable without the force applied by the at least one driving bar.

23. The encoder of claim 14, wherein a first cleaning member contacts the at least one surface of the encoder scale during a first reciprocal movement and a second cleaning member contacts the at least one surface of the encoder scale during a second reciprocal movement.

24. The encoder of claim 14, wherein each of the plurality of cleaning members include a bent portion at an end thereof to apply constant pressure on the at least one surface of the encoder scale during the reciprocal movement, and each of the plurality of cleaning members includes a cleaning material disposed at the bent portion to contact the at least one surface.

25. The encoder of claim 14, wherein the at least one cleaning unit comprises a first cleaning unit disposed at a first end of the housing and along a first surface of the encoder scale to clean the first surface of the encoder scale during the reciprocal movement and a second cleaning unit disposed at a second end of the housing and along a second surface of the encoder scale opposite the first surface to clean the second surface of the encoder scale during the reciprocal movement.

26. The encoder of claim 25, wherein the first and second ends of the housing are opposite each other such that the first and second cleaning units are diagonally arranged with respect to each other.

27. The encoder of claim 14, further comprising:
a rotating part to rotate the at least one cleaning unit to select a different one of the plurality of cleaning members each time the carriage reaches a predetermined location along a reciprocal movement path of the carriage.

28. An encoder cleaner usable with an encoder and an encoder housing that are reciprocally movable with a carriage in an image forming apparatus, the encoder cleaner comprising:
a rotary body rotatably disposed about an axis on the encoder housing; and
one or more cleaning members projecting from the rotary body in a radial arrangement to contact a surface of an encoder scale of the encoder and to clean the surface thereof during a reciprocal movement of the carriage.

29. The encoder cleaner of claim 28, wherein the one or more cleaning members comprise a plurality of cleaning members, and the encoder cleaner further comprises:
a rotating part to rotate the rotary body to select a different one of the plurality of cleaning members each time the carriage reaches a predetermined location along a reciprocal movement path thereof.

30. The encoder cleaner of claim 29, wherein the rotary body is disposed on the encoder housing such that the rotary body is prevented from rotating without the rotating part.

31. The encoder cleaner of claim 28, wherein the rotary body has a rotation period having a plurality of steps of a predetermined pitch, and the predetermined pitch is determined by a number of the one or more cleaning members that project therefrom.

32. The encoder cleaner of claim 31, wherein a number of reciprocal movements performed by the carriage during the rotation period of the rotary body is equal to the number of the one or more cleaning members projecting from the rotary body.

33. An encoder cleaner to clean an encoder scale in an image forming apparatus, the encoder cleaner comprising:
a first cleaning unit movable with a carriage of the image forming apparatus and having a first plurality of cleaning parts extending therefrom and disposed on a first side of the encoder scale to clean the first side of the encoder scale with a first selected cleaning part as the carriage moves along the encoder scale; and
a second cleaning unit movable with the carriage of the image forming apparatus and having a second plurality of cleaning parts extending therefrom and disposed on a second side of the encoder scale to clean the second side of the encoder scale with a second selected cleaning part as the carriage moves along the encoder scale.

34. An image forming apparatus, comprising:
a carriage having a recording/reading head mounted thereon to reciprocate along a movement path;
an encoder scale positioned along the movement path of the carriage;
at least one encoder sensor to measure displacement of the carriage with reference to the encoder scale;
a sensor housing provided on the carriage to support the at least one encoder sensor; and
at least one cleaning unit disposed in the sensor housing to clean the encoder scale, and the cleaning unit comprising,
a rotary body rotatably disposed on the sensor housing,
a plurality of unit blades protruding from the rotary body at regular intervals in a radial arrangement, and
a driving bar to rotate the rotary body by a predetermined step by selectively interfering with one of the plurality of unit blades according to a position of the carriage.
